(19) United States
(12) Patent Application Publication
(10) Pub. No.: US 2026/0298859 A1
(43) Pub. Date: Oct. 1, 2026

(54) Flexible Smart Sensor Decal with Integrated Wireless Communication and Energy Harvesting

(71) Applicant: Kyrilous Basilious, Brentwood, CA (US)

(72) Inventor: Kyrilous Basilious, Brentwood, CA (US)

(21) Appl. No.: 19/578,807

(22) Filed: Mar. 25, 2026

Related U.S. Application Data
(60) Provisional application No. 63/778,419, filed on Mar. 27, 2025.

(51) Int. Cl. G01N 27/22; G01D 11/24; G01D 11/26; G01D 11/30; G01D 21/02; G01N 27/04; G01N 27/12; G01P 1/02; G01P 15/14; G08B 5/36; G08B 21/18; G08B 21/20; G08B 25/10; H02N 2/18

(52) U.S. Cl. CPC G01N 27/223; G01D 11/245; G01D 11/26; G01D 11/30; G01D 21/02; G01N 27/048; G01N 27/121; G01P 1/023; G01P 15/14; G08B 5/36; G08B 21/182; G08B 21/20; G08B 25/10; H02N 2/181; H02N 2/183; H02N 2/186

(57) ABSTRACT

A flexible smart sensor decal includes a flexible substrate, a flexible printed circuit board assembly, at least one moisture sensor, at least one motion sensor, a control circuit, at least one light-emitting diode, a wireless communication module, a flexible energy storage component, a piezoelectric energy harvesting layer, a waterproof encapsulation, and a reusable micro-suction adhesive layer. Mechanical deformation of the decal caused by pressing, tapping, swiping, bending, or surface motion generates electrical energy and can also provide an interaction-related input signal. The control circuit processes sensor inputs to drive local visual feedback and to transmit wireless messages to an external device. The decal can be detachably adhered to a wall, floor, garment, bedding article, machine surface, or other target surface for smart-home control, moisture monitoring, motion monitoring, caregiving alerts, or synchronized visual signaling.

### CROSS-REFERENCE TO RELATED APPLICATIONS

This application claims the benefit of priority under 35 U.S.C. 119(e) to U.S. Provisional Patent Application No. 63/778,419, filed Mar. 27, 2025, entitled “Flexible Smart Sensor Decal with Integrated Wireless Communication and Energy Harvesting,” the entire disclosure of which is incorporated herein by reference to the extent permitted.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR A JOINT INVENTOR

To the extent any disclosure by the inventor or a joint inventor occurred before the effective filing date of any presently claimed subject matter, Applicant reserves the right to rely on any applicable grace period or exception available under 35 U.S.C. 102.

### FIELD OF THE INVENTION

The present invention relates generally to smart sensors, flexible electronics, and Internet-of-Things systems. More particularly, the invention relates to a flexible, adhesive, waterproof electronic decal that integrates sensing, wireless communication, local visual feedback, flexible energy storage, and energy harvesting in a thin conformable structure suitable for smart-home, industrial, healthcare, caregiving, and other connected-device applications.

In representative embodiments, the decal functions as a removable surface-mounted interface and/or surface-monitoring node that can detect user interactions and environmental conditions associated with a surface to which the decal is attached, generate visual and wireless responses, and harvest mechanical energy arising from pressing, bending, tapping, or vibration.

### BACKGROUND OF THE INVENTION

Modern sensing and control systems are commonly deployed in homes, workplaces, industrial settings, healthcare environments, and consumer devices. Although wireless sensors and interactive devices are widely used, many existing products remain rigid, visually intrusive, difficult to install, or dependent on permanent power connections and single-use adhesive structures.

Existing smart buttons, wearables, and environmental sensors often provide only a subset of the functions desirable for a surface-mountable smart decal. Some systems provide wireless communication but are not readily repositionable. Other systems provide flexible sensing but lack integrated local visual feedback or lack an energy harvesting arrangement that can recover energy from ordinary interaction with the device.

Traditional switches and sensors also tend to separate human interaction from power generation. In many systems, a user input merely triggers an electronic response, while device power must be supplied independently by hard wiring, replaceable batteries, or other dedicated power arrangements. This separation can complicate installation, increase maintenance, and limit the ability to deploy intelligent interfaces in ad hoc locations.

In healthcare and caregiving applications, a thin waterproof patch capable of detecting moisture, remaining comfortable near the body, and wirelessly communicating alerts can be highly useful. Yet many known patches are designed primarily for single-use biomedical sensing rather than repeated repositioning across different surfaces while also functioning as a general user interface or indicator.

There is therefore a need for a flexible smart decal that can be detachably adhered to a target surface, can sense user interaction and surface-related environmental conditions, can provide local visual feedback, can communicate wirelessly with external devices, and can harvest at least part of its operating energy from mechanical deformation of the decal itself.

There is a further need for a smart decal that can incorporate expressive graphics or artwork so that the device can guide intuitive interaction, blend aesthetically into a setting, or disguise its technological nature while still performing sensing and communication functions.

### BRIEF SUMMARY OF THE INVENTION

The present disclosure provides a flexible smart sensor decal that integrates, in a single conformable assembly, a flexible substrate, a flexible printed circuit assembly, one or more sensors, at least one LED, a control circuit, a wireless communication module, a flexible energy storage element, an energy harvesting layer, a waterproof encapsulation, and a reusable adhesive arrangement.

In some embodiments, the decal is configured to be detachably secured to a target surface by a reusable micro-suction adhesive layer. The reusable adhesive arrangement allows the decal to be attached, removed, cleaned, and reattached multiple times without substantial loss of adhesion and without leaving significant residue on the target surface.

In some embodiments, user interaction with the decal, such as a press, tap, swipe, sustained contact, flexure, or other gesture, is detected by one or more interaction sensors and/or by an energy harvesting element that also functions as an input-generating component. The same mechanical interaction can therefore both produce an input event and generate electrical energy used to wake circuitry, recharge or supplement stored energy, drive local visual feedback, and/or support wireless transmission.

In some embodiments, the decal additionally or alternatively senses environmental conditions associated with the target surface to which the decal is attached. Representative environmental conditions include moisture, wetness, liquid contact, temperature, vibration, acceleration, direction, orientation, and other physical parameters relevant to the underlying or adjacent surface.

In some embodiments, the decal includes a piezoelectric energy harvesting layer arranged to generate electrical energy in response to pressing, bending, flexing, or vibration. The harvested electrical energy may be rectified, conditioned, stored, or used directly to supplement operation of the control circuit, LED output, and wireless communication module.

In some embodiments, one or more LEDs are driven to provide visual feedback representative of interaction intensity, sensor status, wireless activity, alert conditions, or synchronized display patterns. The LEDs may be aligned with printed graphics, icons, or other indicia on the outward-facing surface of the decal to improve usability and aesthetics.

In some embodiments, the decal functions as a removable surface-mounted user interface capable of controlling an external device without the need for permanent wire routing or hard-mounted switch hardware. Representative examples include wall or floor decals that trigger smart-home actions, machine-mounted decals that report vibration or motion, and patient-adjacent decals that report moisture events.

In some embodiments, multiple decals are coordinated by one or more external devices so that the decals operate as distributed wireless sensor nodes, synchronized indicators, or collectively managed human-machine interfaces.

These and other features, arrangements, methods of operation, and advantages will be apparent from the following detailed description and the accompanying drawings.

### BRIEF DESCRIPTION OF THE DRAWINGS

FIG. 1 is an exploded view of a representative flexible smart sensor decal showing representative layers of the decal assembly.

FIG. 2 is a functional block diagram showing representative signal flow among an input or sensing stage, a control circuit, a wireless output stage, an LED feedback stage, and a power-management stage.

FIG. 3 is a schematic illustration of representative use of the decal on a wall or floor to generate a wireless control signal for an external device.

FIG. 4 is a schematic illustration showing representative local visual feedback corresponding to interaction intensity or other detected input characteristics.

FIG. 5 is a schematic illustration of a representative caregiving embodiment in which a decal detects moisture associated with a patient-adjacent article and wirelessly notifies a caregiver device.

The drawings are diagrammatic and are not necessarily to scale. Like reference characters may be used to identify like or analogous elements in different figures.

### DETAILED DESCRIPTION OF THE INVENTION

Reference will now be made in detail to representative embodiments of the invention. The embodiments described below are illustrative and not limiting. Persons skilled in the art will understand that features described in connection with one embodiment may be combined with features of other embodiments without departing from the scope of the invention.

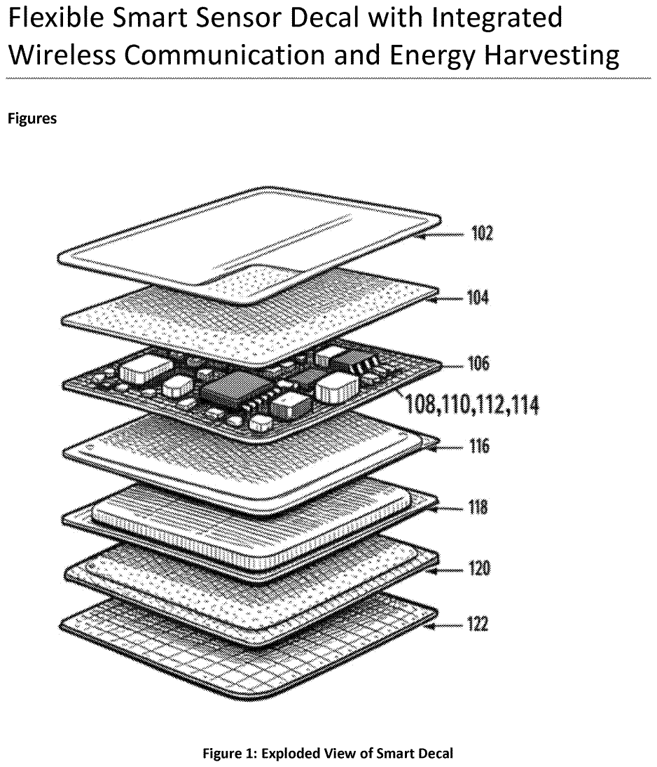

With reference initially to FIG. 1, a flexible smart sensor decal 100 includes an outward-facing side configured to remain exposed during use and an inward-facing side configured to face a target surface 124. The target surface 124 can be a wall, floor, appliance housing, garment, bedding article, patient-adjacent support surface, machine surface, packaging surface, or another surface with which the decal is intended to interact.

The decal 100 may include a waterproof encapsulation layer 102 forming an outer protective boundary for internal electronic elements. The waterproof encapsulation layer 102 can be made from one or more flexible polymers, elastomers, films, or laminates that resist ingress of water, dust, and contaminants while preserving flexibility and durability.

In some embodiments, the outward-facing side of the decal 100 includes a graphic or decorative layer 104. The graphic or decorative layer 104 may include printed indicia such as icons, symbols, emojis, artwork, instructional graphics, branding, caution symbols, or other visible features that identify an interaction region, communicate device status, or cause the decal to visually blend into its environment.

Beneath the outward-facing side, the decal 100 may include a flexible printed circuit assembly 106 supported by the flexible substrate. The flexible printed circuit assembly 106 may carry at least one LED 108, one or more sensors 110, a control circuit 112, and a wireless communication module 114. Because the circuit assembly is flexible, the decal can remain thin, lightweight, and conformable while still supporting active electronics.

The control circuit 112 may comprise a microprocessor, microcontroller, application-specific circuit, programmable logic, or other logic-bearing circuit configured to receive sensor signals, execute stored instructions, determine operating states, and generate output control signals. The control circuit 112 may include on-board memory and may cooperate with discrete power-management circuitry where desired.

The wireless communication module 114 may include one or more short-range or longer-range wireless interfaces. Representative interfaces include Bluetooth, Bluetooth Low Energy, Wi-Fi, wireless mesh interfaces, near-field communication interfaces, cellular interfaces, global positioning system (GPS) or other radio interfaces suitable for transmitting status information, alerts, commands, or other data to an external device.

The decal 100 may further include an energy storage element 116. In representative embodiments, the energy storage element 116 is a thin flexible battery. In other embodiments, the energy storage element 116 may include a thin-film battery, printed battery, flexible supercapacitor, hybrid storage device, or another storage arrangement compatible with a thin conformable layer stack.

The decal 100 may also include an energy harvesting element 118 positioned to generate electrical energy when the decal 100 is mechanically deformed. In certain representative embodiments, the energy harvesting element 118 includes a piezoelectric element that produces an electrical output when bent, pressed, flexed, or vibrated. The electrical output may be coupled to conditioning circuitry and to the energy storage element 116 so that harvested energy recharges or supplements stored energy.

In some embodiments, the energy harvesting element 118 extends across a substantial area of the flexible substrate so that user presses, flexure of the target surface 124, or distributed vibration can be captured over a broad interaction region rather than only at a localized point. This arrangement can increase the opportunity to recover energy from ordinary use and can improve responsiveness of the decal in floor, wall, machine, and caregiving deployments.

In some implementations, the same mechanical interaction that deforms the energy harvesting element 118 is also used by the control circuit 112 as an input event. A press, tap, swipe, or bend can therefore both generate electrical energy and provide a signal indicative of interaction strength, timing, or occurrence. This dual-use arrangement can reduce dedicated parts and can support low-power operation in which a user interaction wakes the device and contributes energy for local feedback and/or transmission.

In some implementations, a protective layer 120 is disposed between internal layers and the adhesive-facing side of the decal 100. The protective layer 120 can help preserve structural integrity, distribute forces, isolate electrical components from the adhesive arrangement, and protect internal components from damage caused by repeated attachment, removal, or surface irregularities.

At the inward-facing side, the decal 100 may include a reusable adhesive layer 122. In preferred embodiments, the reusable adhesive layer 122 comprises a micro-suction material having a plurality of microscopic suction structures distributed across substantially the entire bottom surface of the decal. The reusable adhesive layer 122 can provide secure but detachable adherence to a variety of relatively smooth target surfaces and can permit repeated removal and reattachment without substantial residue.

The micro-suction adhesive arrangement can also facilitate hygienic reuse. In some embodiments, the adhesive-facing side can be washed or cleaned to remove dust, lint, or other contamination, after which the decal 100 can be reapplied without significant loss of adhesion or function. This can be especially beneficial where the decal is repositioned among different walls, floors, garments, bedding articles, or equipment surfaces.

The sensors 110 may include one or more interaction sensors and/or one or more environmental sensors. Representative interaction sensors include capacitive touch sensors, pressure-responsive structures, piezoelectric input structures, and other sensors responsive to a user's press, tap, or swipe. Representative environmental sensors include moisture sensors, wetness sensors, temperature sensors, accelerometers, gyroscopes, magnetometers, and other motion-related sensors.

In one implementation, a moisture sensor 142 comprises conductive electrodes disposed on the flexible substrate and configured to detect the presence of liquid moisture by sensing a change in impedance, resistance, capacitance, or other electrical characteristic between or among the electrodes. The moisture sensor 142 may be positioned so as to sense moisture contacting the decal 100 directly, moisture present at an interface between the decal 100 and the target surface 124, or moisture associated with an adjacent article such as a garment or bedding item.

The sensors 110 may additionally include a multi-axis motion sensor 140, such as an accelerometer, gyroscope, magnetometer, or combination thereof. The multi-axis motion sensor 140 can enable the decal 100 to detect and measure movement, acceleration, vibration, direction, or orientation. In different applications, motion data may correspond to user motion, machine motion, floor vibration, equipment vibration, or other movement coupled to the target surface 124.

The control circuit 112 can analyze signals from the sensors 110 to determine the nature of an input or monitored condition. For example, the control circuit 112 may distinguish among tap, press, swipe, sustained contact, vibration patterns, orientation changes, or threshold moisture events. The determined condition may then be used to select a visual output pattern, a wireless message type, a power-management action, or a combination thereof.

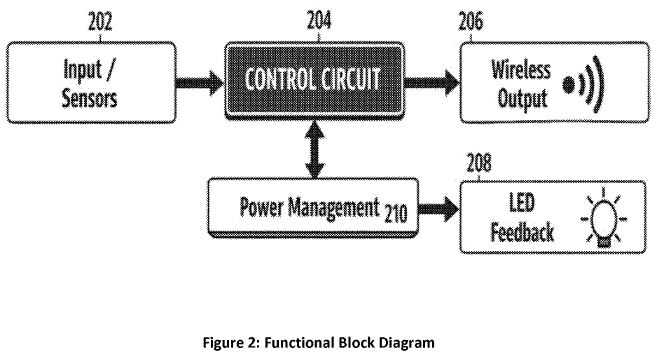

FIG. 2 illustrates a representative logical relationship among an input or sensing stage 202, a control circuit 204, a wireless output stage 206, an LED feedback stage 208, and a power-management stage 210. In one representative operating mode, the input or sensing stage 202 provides interaction or environmental data to the control circuit 204; the control circuit 204 determines a device response; the wireless output stage 206 transmits a message to an external device; the LED feedback stage 208 provides local visual feedback; and the power-management stage 210 conditions harvested energy, manages stored energy, and controls wake and sleep behavior.

Local visual feedback can be highly useful in a decal-based interface. The LEDs 108 may include a single LED, a multicolor LED, or an array of LEDs, including individually addressable LEDs distributed across the flexible substrate. The control circuit 112 may drive the LEDs 108 according to predefined patterns corresponding to user interactions, moisture states, motion states, wireless activity, synchronization sequences, or remotely received commands.

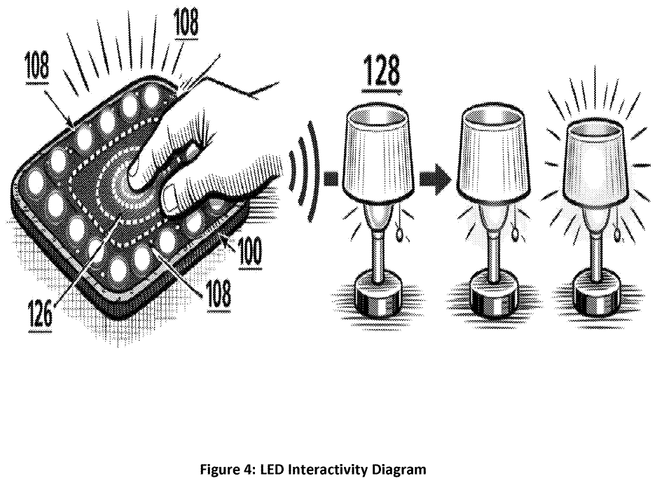

In some embodiments, the control circuit 112 modulates LED behavior based on the strength or character of a press or other deformation. A light press may be represented by a relatively low-intensity or short-duration illumination, whereas a stronger or more abrupt input may be represented by increased intensity, a color change, a different flash pattern, or a broader illuminated region. FIG. 4 schematically illustrates one representative interaction region 126 on the decal 100 and corresponding LED feedback 108.

In some embodiments, the graphical or decorative layer 104 is aligned with the LEDs 108 so that light emitted by the LEDs is visible through, around, or in relation to a graphic region. For example, an icon indicating where a user should step, press, or swipe can become illuminated when the interaction occurs. In another example, the visible indicia are arranged to camouflage the electronic nature of the decal so that the decal resembles a decorative sticker or sign while still providing sensing and wireless capability.

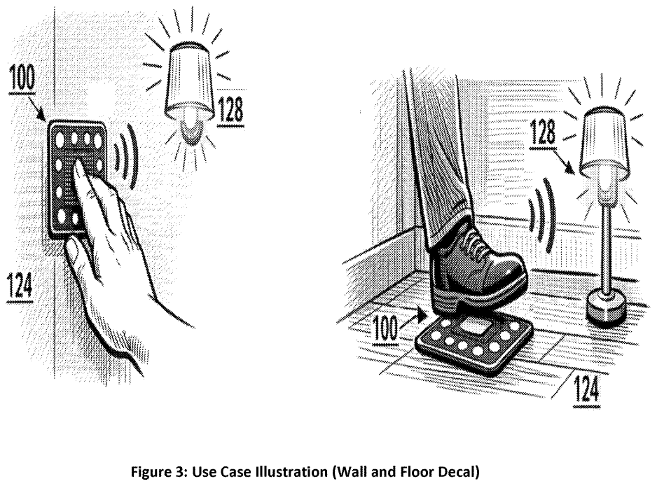

With reference to FIG. 3, the decal 100 may be used as a surface-mounted user interface for home automation or other control functions. In one example, the decal 100 is adhered to a wall or floor and is manually pressed, stepped on, or swiped to cause the control circuit 112 to transmit a wireless message to an external device 128, such as a light fixture, controller, smart-home hub, speaker, or appliance. The external device 128 may then change state in response to the wireless message.

Because the decal 100 can be attached by the reusable adhesive layer 122 and need not be wired into a building surface, installation can be significantly simplified. The decal can function as an interactive control point or indicator at locations where conventional wired switches, buttons, or control panels would be difficult, undesirable, temporary, or visually intrusive.

In some embodiments, the interaction region 126 is formed as part of the membrane structure of the decal 100 so that pressing or swiping on a marked area produces a desired deformation profile. The membrane-like region can cooperate with the energy harvesting element 118 and the sensors 110 to generate a consistent interaction signal while preserving the thin decal form factor.

In another class of embodiments, the decal 100 is used primarily or secondarily as a surface-monitoring device. When adhered to a surface associated with a moisture risk or a motion condition, the sensors 110 may monitor conditions specifically related to the surface where the decal is adhered rather than merely measuring free ambient conditions at a remote location. This can be advantageous for detecting wetness on bedding, leaks on equipment housings, vibration on a machine panel, or motion associated with a floor or support member.

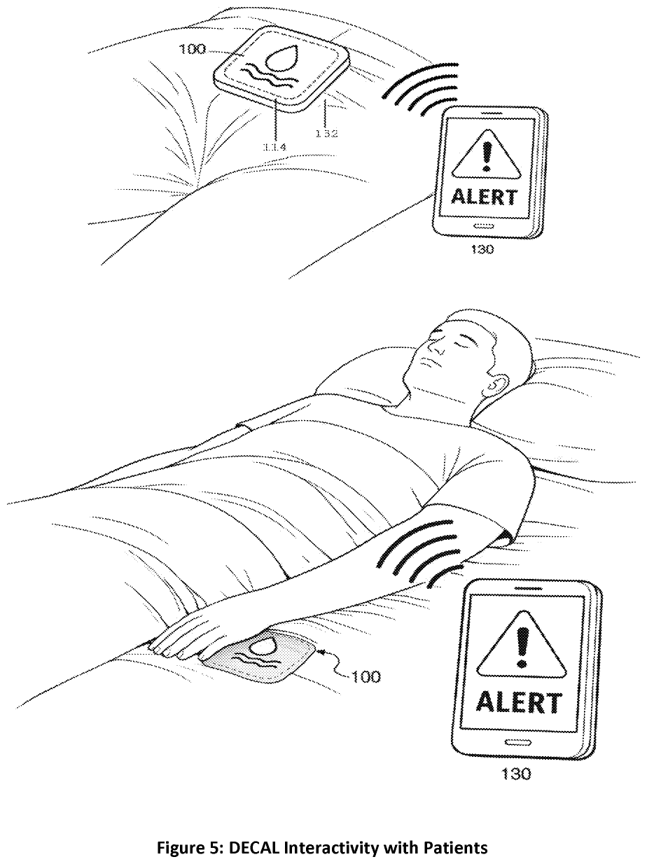

FIG. 5 illustrates a representative caregiving use case in which the decal 100 is placed on or adjacent to a patient-adjacent article 132 such as bedding, a pad, a garment, a support sheet, or another moisture-sensitive surface. When moisture exceeds a predefined threshold, the control circuit 112 may cause the wireless communication module 114 to send an alert to a monitor device 130, such as a smartphone, tablet, laptop computer, nurse-station device, caregiver terminal, or dedicated receiver.

In representative caregiving embodiments, the waterproof encapsulation layer 102 may be formed from a flexible and optionally biocompatible polymer material that protects the internal electronics while permitting comfortable positioning near skin, fabric, or bedding without undue irritation. The thin and waterproof form factor can also facilitate discreet placement and cleaning between uses.

In industrial embodiments, the decal 100 may be mounted on a machine housing, enclosure, floor, panel, or another industrial surface. The motion sensor 140 and/or energy harvesting element 118 can detect vibration, shock, acceleration, or directional changes associated with operation of a machine or system. If a monitored parameter exceeds a threshold, the decal may provide local visual feedback, transmit a maintenance or alarm message, or both.

The motion-sensing capability can also be used in consumer or personal-monitoring contexts. When mounted on a body-adjacent article, personal item, or other motion-coupled surface, the motion sensor 140 can recognize or classify movement patterns such as walking, running, falling, or other activity states, or can distinguish among vibration signatures of different machines or surfaces.

In some embodiments, harvested energy from the energy harvesting element 118 supplements the energy storage element 116 and can be used to power a burst transmission, wake the control circuit 112 from sleep, drive a local LED indication, or recharge the energy storage element over time. A single interaction need not fully power all device operations, but can materially reduce demand on the stored energy source.

Power-management functions may be implemented by the control circuit 112 and/or by separate circuitry associated with the power-management stage 210. Such functions may include entering a low-power sleep mode during inactivity, waking upon detection of a sensor output or piezoelectric signal, selectively enabling the wireless communication module 114 only when transmission is needed, and adapting LED drive behavior based on available stored or harvested energy.

The wireless communication module 114 can communicate directly with the external device 128 or the monitor device 130, or can communicate through an intermediate hub, networked controller, mesh node, gateway, or remote service. A received message may cause an external device to display a visual notification, play an audio notification, generate vibration, transmit a network message, modify the state of another device, log sensor data, or coordinate multiple decals.

In some embodiments, multiple decals 100 are deployed in a shared environment. Each decal may sense local conditions and report its individual status to a common external device, or the external device may coordinate synchronized visual output among a plurality of decals. The coordinated decals can thereby form a distributed interface, signage system, warning system, or monitoring network.

The size, shape, and contour of the decal 100 may vary with the intended application. Some embodiments may be rectangular, circular, oval, elongated, or custom-shaped. The interaction region 126 may occupy most of the decal area or only a selected portion, and the energy harvesting element 118 may be coextensive with or offset from the interaction region depending on the desired tactile and electrical response.

The representative layer order shown in FIG. 1 may be modified so long as the device retains the described functional relationships. Certain sensors may be positioned closer to the target surface 124, other sensors may be positioned closer to the outward-facing side, the graphic layer 104 may be combined with the encapsulation layer 102, and selected circuitry may be implemented in discrete or integrated form.

The flexible printed circuit assembly 106 may be manufactured using flexible substrate materials and conductive traces suitable for repeated bending or flexing within the intended operating range of the product. Conductive traces, protective coatings, and interconnect arrangements may be selected so that the decal remains functional through repeated attachment, removal, interaction, and cleaning cycles.

The reusable adhesive layer 122 may be selected and structured so that the decal can be moved from one surface to another without leaving significant residue. In some implementations, loss of adhesion caused by contamination is mitigated by washing or wiping the adhesive layer and then reapplying the decal after drying.

The control circuit 112 may be programmed with different operating profiles corresponding to different installations. A decal intended for use as a wall control can prioritize gesture recognition and command transmission, whereas a decal intended for caregiving can prioritize moisture detection and alert thresholds, and a decal intended for industrial use can prioritize vibration monitoring and event logging.

In some embodiments, the control circuit 112 determines that a sensed condition exceeds a predefined threshold and then causes both a local response and a remote response. By way of example, detection of moisture can trigger an LED alert pattern and a wireless notification, detection of abnormal machine vibration can trigger a warning pattern and a maintenance message, and a user press can trigger both an acknowledgment light pattern and a control command to an external device.

The decal 100 may also respond to signals received from another device. A nearby smart device or controller can send a command to the decal to cause the LEDs 108 to emit a synchronized or preprogrammed display pattern, thereby allowing the decal to serve not only as a sensor and interface but also as a networked indicator.

In some embodiments, the decal 100 is dimensioned and packaged to be sufficiently thin and flexible to conform to minor irregularities of the target surface 124 while remaining durable enough for repeated user interaction. The waterproof encapsulation 102, the protective layer 120, and the flexible placement of internal components can collectively improve resilience against moisture exposure and mechanical stress.

The decal 100 can thus serve simultaneously as a sensor node, a user interface, a visual indicator, and a partially self-supplementing wireless device. Integrating these functions into a removable, reusable, waterproof decal provides a versatile platform for applications that would otherwise require separate sensors, switches, indicators, and mounting hardware.

Although representative embodiments have been described with particular reference to moisture sensors, motion sensors, touch-sensitive interaction, LEDs, wireless interfaces, flexible batteries, piezoelectric energy harvesting, graphic indicia, and reusable micro-suction adhesion, other equivalent components and arrangements may be used. Additional sensors, processors, storage devices, protective layers, and communication arrangements may be incorporated while remaining within the scope of the invention.

Relative terms such as outward, inward, top, bottom, upper, lower, above, below, front, rear, and side are used for convenience of description and do not require any particular orientation unless expressly stated otherwise. Singular terms include plural referents and vice versa unless the context clearly requires otherwise.

The foregoing description is intended to be illustrative and not limiting. Variations, substitutions, and combinations of the disclosed features may be employed without departing from the spirit of the invention. The scope of protection is defined by the appended claims.

What is claimed is:

1. A flexible smart sensor decal comprising:
a flexible substrate having an outward-facing side and an inward-facing side configured to face a target surface; a flexible printed circuit assembly supported by the flexible substrate and carrying a control circuit, at least one light-emitting diode, and a wireless communication module; at least one moisture sensor electrically coupled to the control circuit and configured to detect moisture contacting the flexible smart sensor decal or moisture present at an interface between the flexible smart sensor decal and the target surface; at least one motion sensor electrically coupled to the control circuit and configured to detect movement, acceleration, vibration, direction, or orientation coupled to the target surface; a flexible energy storage component electrically coupled to the flexible printed circuit assembly; a piezoelectric energy harvesting layer disposed in the decal and electrically coupled to the flexible energy storage component; a waterproof encapsulation enclosing the flexible printed circuit assembly, the flexible energy storage component, and the piezoelectric energy harvesting layer; and a reusable micro-suction adhesive layer on the inward-facing side, the reusable micro-suction adhesive layer comprising a plurality of microscopic suction structures distributed across substantially the entire inward-facing side for detachably adhering the flexible smart sensor decal to the target surface and allowing repeated removal and reattachment without substantial residue; wherein mechanical deformation of the flexible smart sensor decal caused by user interaction with the flexible smart sensor decal or movement of the target surface simultaneously (i) generates electrical energy via the piezoelectric energy harvesting layer and (ii) produces an interaction signal indicative of the user interaction or movement without requiring a secondary dedicated input sensor; and wherein the control circuit is configured to receive the interaction signal and signals from the at least one moisture sensor and the at least one motion sensor, to control local visual feedback through the at least one light-emitting diode, and to transmit a wireless message through the wireless communication module responsive to the interaction signal and/or the signals from the at least one moisture sensor and the at least one motion sensor.

2. The flexible smart sensor decal of claim 1, wherein at least one motion sensor comprises at least one of a 3-axis accelerometer, a gyroscope, or a magnetometer configured to detect movement, acceleration, vibration, direction, or orientation of the target surface or an article coupled to the target surface.

3. The flexible smart sensor decal of claim 1, wherein the at least one moisture sensor comprises conductive electrodes disposed on the flexible substrate and configured to detect liquid moisture by sensing a change in impedance, resistance, capacitance, or another electrical characteristic between or among the conductive electrodes.

4. The flexible smart sensor decal of claim 1, wherein the control circuit is configured to analyze the interaction signal and at least one signal from the at least one moisture sensor or the at least one motion sensor to determine a nature of an input or monitored condition including at least one of a tap, press, swipe, sustained contact, vibration pattern, orientation change, or threshold moisture event, and, based on the determined input or monitored condition, select a visual output pattern or a wireless message type.

5. The flexible smart sensor decal of claim 1, wherein the piezoelectric energy harvesting layer extends across a substantial area of the flexible substrate to increase mechanical energy capture from pressing, bending, flexure of the target surface, or vibration.

6. The flexible smart sensor decal of claim 1, wherein electrical energy generated by the piezoelectric energy harvesting layer recharges or supplements energy stored in the flexible energy storage component and is usable to wake the control circuit from a low-power state, power a burst wireless transmission, or drive a local light indication.

7. The flexible smart sensor decal of claim 1, wherein the control circuit is configured to enter a low-power sleep mode during inactivity and to wake upon detection of a signal from the at least one moisture sensor, the at least one motion sensor, or the interaction signal produced by the piezoelectric energy harvesting layer.

8. The flexible smart sensor decal of claim 1, wherein the reusable micro-suction adhesive layer is washable or cleanable to remove dust, lint, or other contamination and thereafter remains capable of reattachment without significant loss of adhesion or device functionality.

9. The flexible smart sensor decal of claim 1, wherein the at least one light-emitting diode comprises a plurality of individually addressable light-emitting diode elements distributed across the flexible substrate, the control circuit being configured to control the plurality of light-emitting diode elements to display dynamic visual patterns corresponding to different sensor conditions or user interactions.

10. The flexible smart sensor decal of claim 1, wherein the outward-facing side includes graphical indicia aligned with the at least one light-emitting diode such that emitted light is visible through, around, or in relation to the graphical indicia, and the graphical indicia are arranged to camouflage sensor and electronic components so that the flexible smart sensor decal resembles a decorative sticker or sign.

11. The flexible smart sensor decal of claim 1, wherein the at least one moisture sensor is positioned to detect moisture associated with a garment, bedding article, pad, support sheet, or patient-adjacent support surface adjacent the flexible smart sensor decal.

12. The flexible smart sensor decal of claim 11, wherein the control circuit is configured, when moisture detected by the at least one moisture sensor exceeds a threshold, to cause both a local alert pattern through the at least one light-emitting diode and a wireless alert message through the wireless communication module.

13. The flexible smart sensor decal of claim 1, further comprising a protective layer disposed between internal layers of the flexible smart sensor decal and the reusable micro-suction adhesive layer, the protective layer being configured to distribute forces, isolate electrical components from the reusable micro-suction adhesive layer, and protect internal components from damage caused by repeated attachment, removal, or surface irregularities.

14. The flexible smart sensor decal of claim 1, wherein the waterproof encapsulation comprises a flexible, biocompatible polymer material that protects internal electronics while permitting direct contact with skin or fabric without substantial irritation.

15. The flexible smart sensor decal of claim 1, wherein the flexible smart sensor decal is configured to operate without a wired power connection to the target surface, at least one operational function including wireless transmission or LED output of the flexible smart sensor decal being powered at least partially by electrical energy generated by the piezoelectric energy harvesting layer.

16. The flexible smart sensor decal of claim 1, wherein, when the flexible smart sensor decal is attached to a wall or a floor, the control circuit is configured to transmit a wireless control command to an external device in response to a press, step, or swipe applied to the flexible smart sensor decal.

17. The flexible smart sensor decal of claim 1, wherein the control circuit is configured to determine that a sensed condition exceeds a threshold and, in response, to cause both a local response through the at least one light-emitting diode and a remote response through the wireless communication module.

18. A method of operating a flexible smart sensor decal, the method comprising: detachably adhering the flexible smart sensor decal to a target surface by a reusable micro-suction adhesive layer; mechanically deforming the flexible smart sensor decal by pressing, tapping, swiping, bending, or by movement of the target surface; simultaneously generating electrical energy and producing an interaction signal from the mechanical deformation by a piezoelectric energy harvesting layer disposed in the flexible smart sensor decal; detecting, with at least one moisture sensor of the flexible smart sensor decal, moisture contacting the flexible smart sensor decal or moisture present at an interface between the flexible smart sensor decal and the target surface; detecting, with at least one motion sensor of the flexible smart sensor decal, movement, acceleration, vibration, direction, or orientation coupled to the target surface; receiving, by a control circuit of the flexible smart sensor decal, the interaction signal and signals from the at least one moisture sensor and the at least one motion sensor; controlling at least one light-emitting diode of the flexible smart sensor decal to provide local visual feedback; and transmitting a wireless message to an external device in response to the interaction signal and/or the signals from the at least one moisture sensor and the at least one motion sensor.

19. The method of claim 18, wherein the target surface is selected from a wall, a floor, a garment, a bedding article, a patient-adjacent support surface, and a machine surface, and wherein the wireless message changes a state of a controlled device or provides an alert corresponding to detected moisture, vibration, acceleration, orientation change, or another sensed condition.

20. A monitoring and control system comprising: at least one flexible smart sensor decal according to claim 1; and an external device comprising a wireless receiver and a processor configured to receive the wireless message from the at least one flexible smart sensor decal and, based on the wireless message, present a notification, change a state of a controlled device, log a sensed event, or coordinate synchronized visual output among a plurality of the flexible smart sensor decals.
